(19) United States
(12) Patent Application Publication
(10) Pub. No.: US 2026/0309353 A1
(43) Pub. Date: Oct. 8, 2026

(54) DETECTION SYSTEM AND DETECTION METHOD

(71) Applicant: Panasonic Intellectual Property Management Co., Ltd., Osaka (JP)

(72) Inventors: Kazuo ITOH, Osaka (JP); Kenichiro TANAKA, Osaka (JP); Tatsuo KOGA, Kanagawa (JP)

(21) Appl. No.: 19/482,905

(22) PCT Filed: Mar. 29, 2024
(86) PCT No.: PCT/JP2024/013075

§ 371 Date: Nov. 10, 2025

(30) Foreign Application Priority Data
May 26, 2023 (JP) 2023-087136

(51) Int. Cl. F24F 11/79; F24F 1/0047; F24F 110/10; G01J 5/48

(52) U.S. Cl. CPC F24F 11/79; F24F 1/0047; G01J 5/48; F24F 2110/10

(57) ABSTRACT

A detection system includes an environment control device, an energy emitting unit, an acquirer, and a detector. The energy emitting unit is capable of outputting electromagnetic wave energy including at least one of light or heat from an attachment position of the environment control device in a predetermined direction. The acquirer is configured to acquire distribution information including at least one of first distribution information relating to an electromagnetic field intensity distribution on the ceiling surface of the room or second distribution information relating to an electromagnetic field intensity distribution on a floor surface of the room. The detector is configured to detect, based on the distribution information acquired by the acquirer, attachment position information relating to the attachment position of the environment control device on the ceiling surface.

### TECHNICAL FIELD

The present disclosure relates to detection systems. More specifically, the present disclosure relates to a detection system and a detection method which detect an attached state of an environment control device installed on a ceiling surface of a room.

### BACKGROUND ART

Patent Literature 1 discloses an assist device that derives, based on respective pieces of heat image data detected by a plurality of air conditioners installed in an identical space, a relative positional relationship of the plurality of air conditioners.

In the assist device described in Patent Literature 1, when only one air conditioner is installed in a space, the attachment position of the air conditioner (environment control device) cannot be detected.

### CITATION LIST

### Patent Literature

Patent Literature 1: WO 2018/051479 A1

### SUMMARY OF INVENTION

It is an object of the present disclosure to provide a detection system and a detection method which are capable of detecting attachment position information relating to an attachment position of an environment control device.

A detection system of an aspect of the present disclosure includes an environment control device, an energy emitting unit, an acquirer, and a detector. The environment control device is configured to be installed on a ceiling surface of a room to control an environment in an interior space of the room. The energy emitting unit is capable of outputting electromagnetic wave energy including at least one of light or heat from an attachment position of the environment control device in a predetermined direction. The acquirer is configured to acquire distribution information including at least one of first distribution information relating to an electromagnetic field intensity distribution on the ceiling surface of the room or second distribution information relating to an electromagnetic field intensity distribution on a floor surface of the room. The detector is configured to detect, based on the distribution information acquired by the acquirer, attachment position information relating to the attachment position of the environment control device on the ceiling surface.

A detection method of an aspect of the present disclosure includes an energy emitting process, an acquisition process, and a detection process. The energy emitting process includes causing an energy emitting unit to output electromagnetic wave energy including at least one of light or heat from an attachment position of an environment control device in a predetermined direction. The environment control device is configured to be installed on a ceiling surface of a room to control an environment in an interior space of the room. The acquisition process includes acquiring distribution information including at least one of first distribution information relating to an electromagnetic field intensity distribution on the ceiling surface of the room or second distribution information relating to an electromagnetic field intensity distribution on a floor surface of the room. The detection process includes detecting, based on the distribution information acquired in the acquisition process, attachment position information relating to the attachment position of the environment control device on the ceiling surface.

### BRIEF DESCRIPTION OF DRAWINGS

FIG. 1 is a schematic block diagram of a detection system according to an embodiment of the present disclosure;

FIG. 2 is a schematic illustrative view for illustrating a detection method by the detection system;

FIG. 3 is a view, as seen from below, of a state where an energy emitting unit provided for the environment control device outputs electromagnetic wave energy downward;

FIG. 4 is a view, as seen from below, of a state where the energy emitting unit provided for the environment control device outputs the electromagnetic wave energy rightward;

FIG. 5 is a view, as seen from below, of a state where the energy emitting unit provided for the environment control device outputs the electromagnetic wave energy leftward;

FIG. 6 is a flowchart illustrating operation of the detection system;

FIG. 7 is a schematic illustrative view illustrating a detection method by a detection system according to a first variation;

FIG. 8 is a schematic illustrative view illustrating a detection method by a detection system according to a second variation;

FIG. 9 is a schematic illustrative view illustrating a detection method by a detection system according to the second variation;

FIG. 10 is a schematic block diagram of a detection system according to a fourth variation;

FIG. 11 is a schematic diagram of a room to which a detection system according to a fifth variation has been applied;

FIG. 12 is a view, as seen from below, of a state where an environment control device included in the detection system according to the fifth variation outputs warm air downward;

FIG. 13 is a view, as seen from below, of a state where the environment control device of the fifth variation outputs the warm air rightward;

FIG. 14 is a view, as seen from below, of a state where the environment control device of the fifth variation outputs the warm air leftward;

FIG. 15 is a schematic diagram of a room to which a detection system of a sixth variation has been applied;

FIG. 16 is a schematic diagram of a room to which a detection system of a sixth variation has been applied; and

FIG. 17 is a schematic diagram of a room to which a detection system of a sixth variation has been applied.

### DESCRIPTION OF EMBODIMENTS

A detection system according to an embodiment will be described below in detail with reference to the drawings. Note that figures described in the following embodiment are schematic views, and the dimensional ratio of the sizes and the like of components in these figures does not necessarily correspond to their actual dimensional ratio. Moreover, configurations in the embodiment described below are mere examples of the present disclosure. The present disclosure is not limited to the embodiment described below and may be modified variously depending on design and the like as long as the effect of the present disclosure is provided.

### Embodiment

### (1) Overview

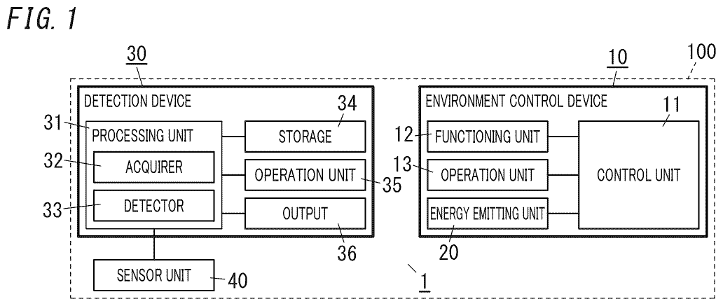

FIG. 1 is a schematic block diagram of a detection system 1 according to the present embodiment.

The detection system 1 of the present embodiment includes an environment control device 10, an energy emitting unit 20, an acquirer 32, and a detector 33.

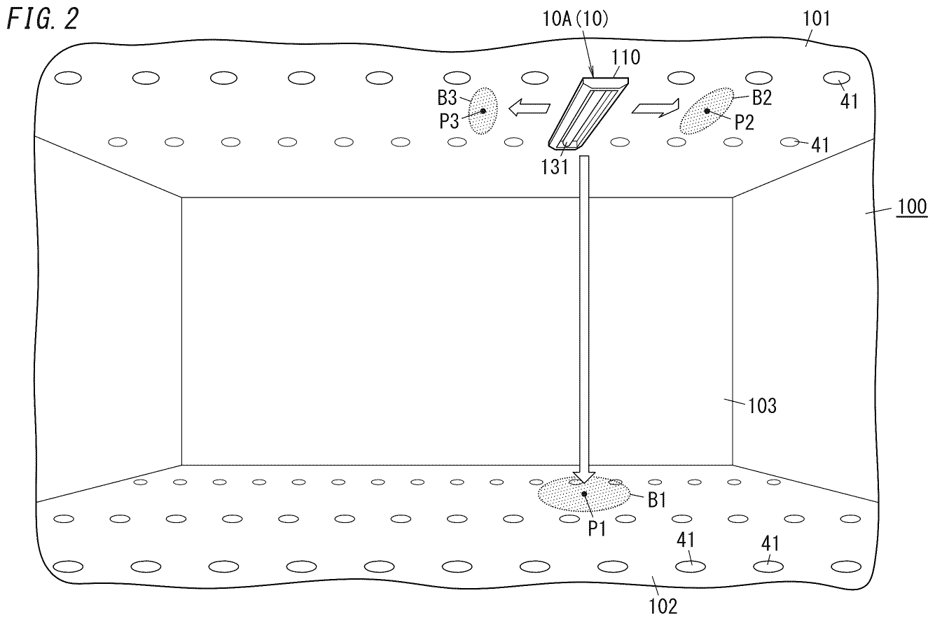

The environment control device 10 is installed on a ceiling surface 101 (FIG. 2) of a room 100 to control an environment in an interior space 103 of the room 100.

The energy emitting unit 20 is capable of outputting electromagnetic wave energy including at least one of light or heat from an attachment position of the environment control device 10 in a predetermined direction.

The acquirer 32 acquires distribution information including at least one of first distribution information relating to an electromagnetic field intensity distribution on the ceiling surface 101 of the room 100 or second distribution information relating to an electromagnetic field intensity distribution on a floor surface 102 of the room 100.

The detector 33 detects, based on the distribution information acquired by the acquirer 32, attachment position information relating to the attachment position of the environment control device 10 on the ceiling surface 101.

The detection system 1 of the present embodiment is used to detect the attachment position information relating to the attachment position of the environment control device 10, for example, when the environment control device 10 is furnished, or when the installation position of the environment control device 10 is changed.

Here, the interior space 103 of the room 100 is a space under the ceiling surface 101. The interior space 103 is, for example, a space surrounded by walls but may be open to the outside through an opening such as a window or an exit/entrance port. The environment control device 10 is a device that controls the environment in the interior space 103 of the room 100. The environment, which is a control target of the environment control device 10, may include, for example, a brightness environment and a temperature and humidity environment in the interior space 103. In the present embodiment, an example will be explained in which the environment control device 10 is a lighting device 10A (see FIG. 2) that controls the brightness environment in the interior space 103 of the room 100, and the lighting device 10A, which is the environment control device 10, controls the brightness in the interior space 103 of the room 100.

Moreover, the attachment position information relating to the attachment position of the environment control device 10 on the ceiling surface 101 is, for example, a position coordinate showing the attachment position of the environment control device 10 on the ceiling surface 101 (e.g., a position coordinate in a two-dimensional orthogonal coordinate system with a predetermined position on the ceiling surface 101 as the origin). Note that the attachment position information relating to the attachment position of the environment control device 10 is not limited to the position coordinate in the two-dimensional orthogonal coordinate system. The attachment position information may be a position coordinate in a three-dimensional orthogonal coordinate system with a predetermined position of the room 100 as the origin and may accordingly be changed as long as it is information that can specify the attachment position of the environment control device 10.

In the detection system 1 of the present embodiment, the energy emitting unit 20 outputs the electromagnetic wave energy from the attachment position of the environment control device 10 in the predetermined direction, which can change at least one of the electromagnetic field intensity distribution on the ceiling surface 101 or the electromagnetic field intensity distribution on the floor surface 102. Since the acquirer 32 acquires the distribution information including at least one of the first distribution information relating to the electromagnetic field intensity distribution on the ceiling surface 101 or the second distribution information relating to the electromagnetic field intensity distribution on the floor surface 102, the detector 33 can detect, based on the distribution information acquired by the acquirer 32, a distribution of the electromagnetic wave energy output from the energy emitting unit 20. Therefore, the detector 33 can detect, based on the distribution information acquired by the acquirer 32, the position of the energy emitting unit 20 on the ceiling surface 101, that is, the attachment position information relating to the attachment position of the environment control device 10. Thus, the present embodiment can provide the detection system 1 capable of detecting the attachment position information relating to the attachment position of the environment control device 10.

Note that in the detection system 1 of the present embodiment, the detector 33 further detects attachment direction information relating to an attachment direction of the environment control device 10 on the ceiling surface 101. The attachment direction information is information indicating a direction in which a reference direction of a housing 110 (see FIG. 2) of the environment control device 10 is pointing when the environment control device 10 is installed on the ceiling surface 101. For example, when the housing 110 has an elongated shape and a long axis direction of the housing 110 is defined as the reference direction, the attachment direction information is information indicating in which direction the reference direction (the long axis direction) of the housing 110 on the ceiling surface 101 is directed. Detecting the attachment direction information by the detector 33 enables the attached state of the environment control device 10 to be detected in further detail.

### (2) Details

With reference to FIGS. 1 to 6, the detection system 1 according to the present embodiment will be described in detail below.

### (2.1) Configuration

In the present embodiment, the environment control device 10 is assumed to be the lighting device 10A, and the detection system 1 is assumed to detect attachment position information relating to an attachment position of the lighting device 10A. FIG. 2 is a schematic diagram showing the interior space 103 of the room 100 in which the lighting device 10A, which is the environment control device 10, is installed.

As described above, the detection system 1 includes the environment control device 10 (in the present embodiment, the lighting device 10A) and a detection device 30. Moreover, the detection system 1 further includes a sensor unit 40. The configuration of each of components of the detection system 1 will be described below.

### (2.1.1) Environment Control Device

The environment control device 10 is installed on the ceiling surface 101 of the room 100. In the present embodiment, the environment control device 10 is, for example, the lighting device 10A. In, for example, FIG. 2, only one lighting device 10A is installed on the ceiling surface 101, but a plurality of lighting devices 10A may be installed on the ceiling surface 101, and the detection system 1 is capable of detecting the attachment position information relating to the attachment position of each of the plurality of lighting devices 10A.

The environment control device 10 (the lighting device 10A) includes a control unit 11, a functioning unit 12, an operation unit 13, the energy emitting unit 20, and the housing 110 (see FIG. 2).

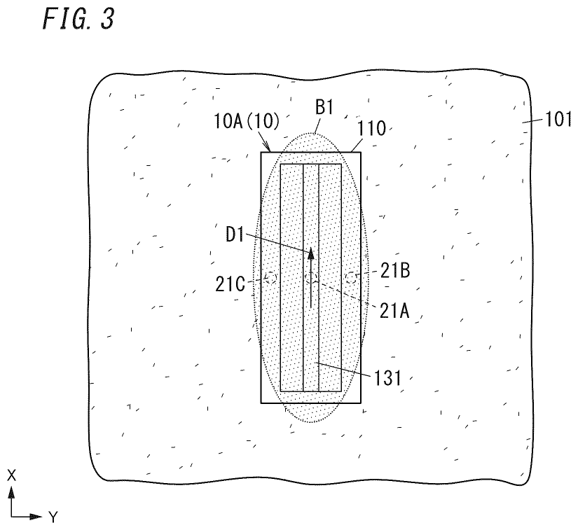

The housing 110 of the lighting device 10A is installed in a state where part of the housing 110 is embedded in the ceiling surface 101. The housing 110 has a rectangular shape when viewed from below. FIGS. 3 to 5 are views of the lighting device 10A installed on the ceiling surface 101 as seen from below. In the following description, an X-axis direction extending along a long side of the housing 110 is referred to as a front/rear direction, a Y-axis direction extending along a short side of the housing 110 is referred to as a left/right direction, and a direction orthogonal to the X-axis direction and the Y-axis direction is referred to as an up/down direction. Moreover, a positive direction of the X axis is defined as a front side, and a positive direction of the Y axis is defined as a right side. However, these directions are mere examples and are not intended to limit the direction in which the environment control device 10 is used. Moreover, arrows indicating the respective directions are shown in the drawings only for the sake of description and are intangible.

The functioning unit 12 provides a function of controlling the environment in the interior space 103 of the room 100. When the environment control device 10 is the lighting device 10A, the functioning unit 12 includes: a light source 131, such as a light-emitting diode or a fluorescent lamp; and a lighting circuit which lights the light source. The functioning unit 12 provides a function of controlling the brightness in the interior space 103 of the room 100, in other words, a function of illuminating the interior space 103.

The operation unit 13 includes, for example, a push button switch on a surface of the housing 110 and receives an operation input given by a user. The operation unit 13 receives a switching operation of switching between an output state where the energy emitting unit 20 outputs the electromagnetic wave energy and a deactivated state where the energy emitting unit 20 outputs no electromagnetic wave energy. Moreover, since the energy emitting unit 20 of the present embodiment is capable of outputting the electromagnetic wave energy to a plurality of directions, the operation unit 13 receives a switching operation of switching the direction in which the energy emitting unit 20 outputs the electromagnetic wave energy to any one of the plurality of directions. Upon receiving the switching operation (of switching between the output state and the deactivated state, of switching between the output directions) given by the user, the operation unit 13 outputs, to the control unit 11, a switching signal according to the switching operation. Note that the operation unit 13 may include a receiver that receives a switching signal transmitted from a remote-control transmitter, and the user can switch between the output state and the deactivated state and can switch between the output directions by using the remote-control transmitter.

As described above, the energy emitting unit 20 is capable of outputting the electromagnetic wave energy including at least one of light or heat from the attachment position of the environment control device 10 (in the present embodiment, the lighting device 10A) in the predetermined direction. In the present embodiment, the environment control device 10 includes the energy emitting unit 20. That is, the energy emitting unit 20 is housed in the housing 110 of the lighting device 10A.

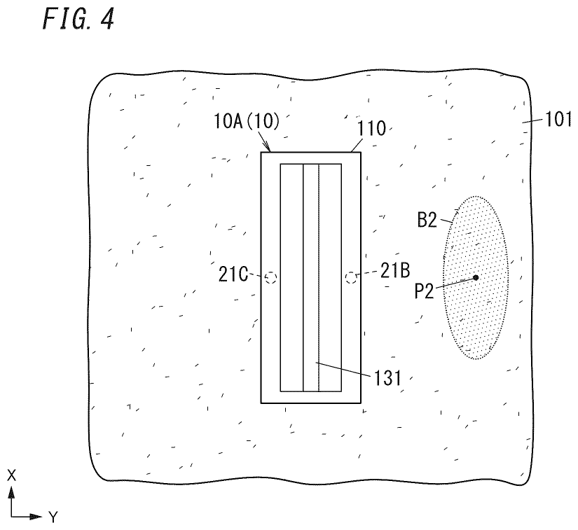

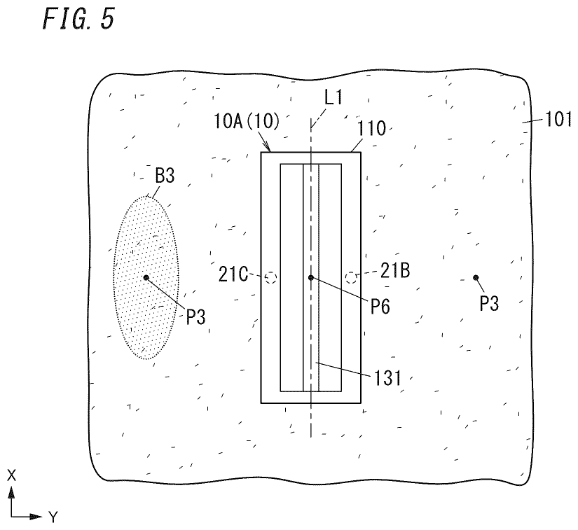

In the present embodiment, the energy emitting unit 20 is capable of outputting an electromagnetic wave with heat radiation in the predetermined direction. Examples of the device capable of outputting the electromagnetic wave with heat radiation include an infrared light-emitting diode, a halogen lamp, and a heater, but in the present embodiment, and an example will be described in which the energy emitting unit 20 includes infrared light-emitting diodes 21A to 21C (see FIGS. 3 to 5) capable of outputting an electromagnetic wave in an infrared region (infrared light) in the predetermined direction. Note that in FIGS. 4 and 5, the drawing of the infrared light-emitting diode 21A is omitted.

The infrared light-emitting diode 21A is disposed substantially at the center of the housing 110. A center position of the housing 110 is a center position on a lower surface of the housing 110 and is a center position in the left/right direction and the front/rear direction. In a state where the housing 110 is installed on the ceiling surface 101, the infrared light-emitting diode 21A is capable of outputting infrared light vertically downward from substantially the center of the housing 110. The infrared light output from the infrared light-emitting diode 21A is radiated to an elliptically circular region B1 (see FIGS. 2 and 3) of the floor surface 102.

The infrared light-emitting diode 21B is disposed at a right end portion of the housing 110, substantially at the center in a longitudinal direction of the housing 110. In the state where the housing 110 is installed on the ceiling surface 101, the infrared light-emitting diode 21B is capable of outputting infrared light rightward from substantially the center of the long side of the housing 110. The infrared light output from the infrared light-emitting diode 21B is radiated to an elliptically circular region B2 which is part of the ceiling surface 101 and which is on the right side of the housing 110 (see FIGS. 2 and 4).

The infrared light-emitting diode 21C is disposed at a left end portion of the housing 110, substantially at the center in the longitudinal direction of the housing 110. In the state where the housing 110 is installed on the ceiling surface 101, the infrared light-emitting diode 21C is capable of outputting infrared light leftward substantially from the center of the long side of the housing 110. The infrared light output from the infrared light-emitting diode 21C is radiated to an elliptically circular region B3 which is part of the ceiling surface 101 and which is on the left side of the housing 110 (see FIGS. 2 and 5). Here, the infrared light-emitting diode 21C and the infrared light-emitting diode 21B are capable of outputting the infrared light in opposite directions of the center position of the housing 110 from each other. Therefore, the region B2 irradiated with the infrared light from the infrared light-emitting diode 21B and the region B3 irradiated with the infrared light from the infrared light-emitting diode 21C are regions symmetric to a straight line which passes through the center position of the housing 110 and which is parallel to the long axis direction of the housing 110.

The control unit 11 includes, as a main component, for example, a computer system including one or more processors and one or more memory elements. The processor(s) included in the computer system executes a program(s) stored in the memory element(s), thereby implementing a function as the control unit 11. The program(s) may be stored in the memory element(s), may be provided over a telecommunications network such as the Internet, or may be distributed after having been stored in a non-transitory recording medium such as a memory card.

The control unit 11 controls the functioning unit 12. For example, the control unit 11 controls the lighting circuit such that the light source is lit at predetermined brightness. Note that the control unit 11 may control the lighting circuit to change the brightness of the light source such that the predetermined brightness is achieved in the interior space 103 of the room 100. Moreover, the control unit 11 performs, in accordance with the switching signal input from the operation unit 13, control such that the energy emitting unit 20 is in the output state where the electromagnetic wave with heat radiation in the predetermined direction is output or the deactivated state.

### (2.1.2) Sensor Unit

In the present embodiment, the energy emitting unit 20 outputs the electromagnetic wave with heat radiation, and therefore, the sensor unit 40 includes a plurality of temperature sensors 41 (see FIG. 2) disposed on the ceiling surface 101 and the floor surface 102. The plurality of temperature sensors 41 are arranged at regular intervals in the X-axis direction and the Y-axis direction on each of the ceiling surface 101 and the floor surface 102. Here, the plurality of temperature sensors 41 are preferably arranged on each of the ceiling surface 101 and the floor surface 102 at intervals at which a temperature distribution in a state where the energy emitting unit 20 outputs the electromagnetic wave energy is detectable.

Each of the plurality of temperature sensors 41 detects an ambient temperature. Each of the plurality of temperature sensors 41 includes, for example, a sensing unit and an output.

The sensing unit incudes, for example, a thermosensor such as a thermistor to detect the ambient temperature.

The output outputs a sensing result by the sensing unit to the detection device 30. An individual identification number is assigned to each of the plurality of temperature sensors 41, and the output outputs the sensing result by the sensing unit and the identification number to the detection device 30. Note that a communication scheme between the output of the temperature sensor 41 and the detection device 30 is, for example, a serial communication schema such as RS485, but the communication scheme may accordingly be changed.

### (2.1.3) Detection Device

The detection device 30 includes a processing unit 31, a storage 34, an operation unit 35, and an output 36.

The storage 34 includes, for example, a memory element such as Read-Only Memory (ROM) and Random Access Memory (RAM). The storage 34 stores pieces of sensor position information relating to installation positions of the temperature sensors 41 included in the sensor unit 40 in association with the identification numbers of the temperature sensors 41. The storage 34 stores, for example, data being calculated by the processing unit 31. Moreover, the storage 34 stores the attachment position information relating to the attachment position of the environment control device 10 and the attachment direction information relating to the attachment direction of the environment control device 10 determined by the detector 33.

The processing unit 31 includes, as a main component, for example, a computer system including one or more processors and one or more memory elements. The processor(s) included in the computer system executes a program(s) stored in the memory element(s), thereby implementing a function as the processing unit 31. The program(s) may be stored in the memory element(s), may be provided over a telecommunications network such as the Internet, or may be distributed after having been stored in a non-transitory recording medium such as a memory card.

The processing unit 31 has functions as the acquirer 32 and the detector 33 described above. Note that the acquirer 32 and the detector 33 merely show functions implemented by the processing unit 31 and do not necessarily embody tangible components.

The acquirer 32 acquires the sensing result and the identification information from each of the plurality of temperature sensors 41 included in the sensor unit 40. Since the pieces of sensor position information relating to the installation positions and the identification numbers of the temperature sensors 41 are stored in the storage 34 in association with each other, the acquirer 32 can acquire, based on the sensing results acquired from the plurality of temperature sensors 41, a temperature distribution on the ceiling surface 101 as the first distribution information and a temperature distribution on the floor surface 102 as the second distribution information. That is, the acquirer 32 acquires the distribution information on the basis of the sensing results by the plurality of temperature sensors 41 disposed on at least one of the ceiling surface 101 or the floor surface 102.

The detector 33 detects, based on the distribution information acquired by the acquirer 32, the attachment position information relating to the attachment position of the lighting device 10A on the ceiling surface 101. Note that in the detection system 1 of the present embodiment, the detector 33 further detects the attachment direction information relating to the attachment direction of the environment control device 10 on the ceiling surface 101. The housing 110 of the lighting device 10A has a rectangular shape when viewed from below, and the detector 33 further detects a direction in which the long axis direction (direction extending along an arrow D1 of FIG. 3) of the housing 110 is directed. Note that a detection method of detecting the attachment position information and the attachment direction information by the detector 33 will be described in “(2.2) Description of Operation”.

The operation unit 35 receives the operation input given by the user. The operation unit 35 includes an operation switch such as a push button switch and an input device such as a keyboard and a mouse. Note that the operation unit 35 may be a unit that receives a speech-based operation instruction given by a user through speech recognition.

The output 36 includes, for example, a display unit, such as a liquid crystal display, and displays the attachment position information and attachment direction information on the environment control device 10 determined by the detector 33 on a screen of the display unit.

### (2.2) Description of Operation

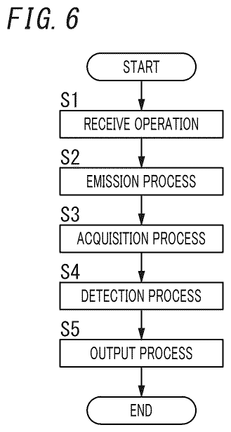

With reference to FIGS. 2 to 6, a process of detecting the attachment position information on the environment control device 10 (in the present embodiment, the lighting device 10A) installed on the ceiling surface 101 by the detection system 1 will be described below. Note that the flowchart shown in FIG. 6 is a mere example of the detection method of detecting the attachment position information on the environment control device 10 by the detection system 1 according to the present embodiment, and the order of processes may accordingly be changed, or a process(es) may accordingly be added or omitted.

To start the process of detecting the attachment position information on the environment control device 10, the user gives, to the operation unit 13 of the environment control device 10, the switching operation of causing the electromagnetic wave energy to be output in the predetermined direction. When the operation unit 13 receives the switching operation given by the user (step S1), the control unit 11 performs, based on the switching signal from the operation unit 13, an emission process of causing the energy emitting unit 20 to output the electromagnetic wave energy in the predetermined direction (step S2). For example, the user performs the switching operation of causing the energy emitting unit 20 to output the electromagnetic wave energy downward, and the control unit 11 thus causes the infrared light-emitting diode 21A to output infrared light downward.

In the state where the energy emitting unit 20 outputs the electromagnetic wave energy downward (i.e., the infrared light-emitting diode 21A outputs the infrared light downward), the user gives an operation to the operation unit 35 to instruct an acquisition process, and the acquirer 32 then acquires the sensing results from the plurality of temperature sensors 41 (step S3). The acquirer 32 acquires, based on the sensing results acquired from the plurality of temperature sensors 41, the first distribution information relating to the temperature distribution on the ceiling surface 101 and the second distribution information relating to the temperature distribution on the floor surface 102. Note that when the infrared light-emitting diode 21A outputs the infrared light downward, the infrared light from the infrared light-emitting diode 21A is radiated to the region B1 of the floor surface 102, and therefore, the region B1 irradiated with the infrared light can be detected by the temperature sensors 41 installed on the floor surface 102. When the infrared light-emitting diode 21A outputs the infrared light downward, it suffices that the acquirer 32 acquires the second distribution information relating to the temperature distribution on the floor surface 102, and therefore, the process of acquiring the first distribution information relating to the temperature distribution on the ceiling surface 101 is omittable.

When the acquisition process by the acquirer 32 is completed, the detector 33 performs, based on the distribution information acquired by the acquirer 32, a detection process of detecting the attachment position information on the lighting device 10A (step S4).

Specifically, the detector 33 determines the region B1, which is part of the floor surface 102 and which is irradiated with the infrared light, from the second distribution information acquired by the acquirer 32, and the detector 33 determines a center position of the region B1 as a position P1 directly under the lighting device 10A. In the present embodiment, the center position of a region irradiated with infrared light means a position of the center of gravity of a region having a temperature higher than or equal to a predetermined threshold. Then, the detector 33 determines a position coordinate of a position which is on the ceiling surface 101 and which is directly above the position P1 as the attachment position information relating to the attachment position of the lighting device 10A.

Upon determining the attachment position information relating to the attachment position of the lighting device 10A, the detector 33 causes the storage 34 to store the sensing result of the attachment position information and outputs the sensing result to the output 36. The output 36 displays the sensing result of the attachment position information, for example, on the screen of the display unit (step S5), and the user can confirm the sensing result of the attachment position information displayed on the screen of the display unit.

Now, a process of detecting the attachment position information and attachment direction information on the environment control device 10 (in the present embodiment, the lighting device 10A) installed on the ceiling surface 101 by the detection system 1 will be described.

To detect the attachment position information and attachment direction information on the lighting device 10A by the detection system 1, the acquirer 32 acquires the distribution information in each of a state where the energy emitting unit 20 outputs electromagnetic wave energy (e.g., infrared light) with heat radiation rightward and a state where the energy emitting unit 20 outputs the electromagnetic wave energy leftward.

First of all, the user gives, to the operation unit 13 of the environment control device 10, a switching operation of causing the electromagnetic wave energy to be output rightward, and the operation unit 13 then receives the switching operation given by the user, and the control unit 11 causes, based on the switching signal from the operation unit 13, the infrared light-emitting diode 21B to output infrared light rightward. In the state where the energy emitting unit 20 outputs the electromagnetic wave energy rightward, the user gives an operation to the operation unit 35 to instruct the acquisition process, and the acquirer 32 then acquires the sensing results from the plurality of temperature sensors 41. The acquirer 32 acquires, based on the sensing results acquired from the plurality of temperature sensors 41, the first distribution information relating to the temperature distribution on the ceiling surface 101 and the second distribution information relating to the temperature distribution on the floor surface 102. When the infrared light-emitting diode 21B outputs the infrared light rightward, the infrared light from the infrared light-emitting diode 21B is radiated to the region B2 of the ceiling surface 101. Therefore, when the infrared light-emitting diode 21B outputs the infrared light rightward, it suffices that the acquirer 32 acquires the first distribution information relating to the temperature distribution on the ceiling surface 101, and therefore, the process of acquiring the second distribution information relating to the temperature distribution on the floor surface 102 is omittable.

Then, the user gives, to the operation unit 13 of the environment control device 10, a switching operation of causing the electromagnetic wave energy to be output leftward, and the operation unit 13 then receives the switching operation given by the user, and the control unit 11 causes, based on the switching signal from the operation unit 13, the infrared light-emitting diode 21C to output infrared light leftward. In the state where the energy emitting unit 20 outputs the electromagnetic wave energy leftward, the user gives an operation to the operation unit 35 to instruct the acquisition process, and the acquirer 32 then acquires the sensing results from the plurality of temperature sensors 41. The acquirer 32 acquires, based on the sensing results acquired from the plurality of temperature sensors 41, the first distribution information relating to the temperature distribution on the ceiling surface 101 and the second distribution information relating to the temperature distribution on the floor surface 102. When the infrared light-emitting diode 21C outputs the infrared light leftward, the infrared light from the infrared light-emitting diode 21C is radiated to the region B3 of the ceiling surface 101. Therefore, when the infrared light-emitting diode 21C outputs the infrared light leftward, it suffices that the acquirer 32 acquires the first distribution information relating to the temperature distribution on the ceiling surface 101, and therefore, the process of acquiring the second distribution information relating to the temperature distribution on the floor surface 102 is omittable.

When the acquirer 32 acquires the distribution information in each of the state where the energy emitting unit 20 outputs the infrared light rightward and the state where the energy emitting unit 20 outputs the infrared light leftward, the detector 33 performs, based on the distribution information acquired by the acquirer 32, the process of detecting the attachment position information relating to the attachment position and the attachment direction information relating to the attachment direction of the lighting device 10A. First of all, the detector 33 determines, based on the first distribution information in the state where the energy emitting unit 20 outputs the infrared light rightward, a position coordinate of a center position P2 (see FIGS. 2 and 4) of the region B2, which is part of the ceiling surface 101 and which is irradiated with the infrared light from the energy emitting unit 20. Then, the detector 33 determines, based on the first distribution information in the state where the energy emitting unit 20 outputs the infrared light leftward, a position coordinate of a center position P3 (see FIGS. 2 and 5) of the region B3, which is part of the ceiling surface 101 and which is irradiated with the infrared light from the energy emitting unit 20. Upon determining the position coordinates of the center positions P2 and P3 respectively of the regions B2 and B3, the detector 33 calculates a position coordinate of a midpoint P6 (see FIG. 5) between the two center positions P2 and P3 to determine a coordinate of the midpoint P6 as the position information relating to the attachment position of the lighting device 10A. Moreover, the detector 33 determines a direction extending along a straight line L1 (see FIG. 5) orthogonal to: a line segment passing through the midpoint P6 between the two center positions P2 and P3 and connecting the center positions P2 and P3 to each other; and a normal to the ceiling surface 101 as a direction in which the reference direction of the housing 110 is directed, and the detector 33 determines information (e.g., vector information) representing the straight line L1 as the attachment direction information.

Upon determining the attachment position information and attachment direction information on the lighting device 10A, the detector 33 causes the storage 34 to store the sensing results of the attachment position information and the attachment direction information, and outputs the sensing results to the output 36. The output 36 displays the sensing results of the attachment position information and the attachment direction information on, for example, the screen of the display unit, and the user can confirm the sensing results of the attachment position information and the attachment direction information displayed on the screen of the display unit. As described above, the detector 33 further detects the attachment direction information relating to the attachment direction of the environment control device 10 on the ceiling surface 101 and can thus detect the attached state of the environment control device 10 in further detail.

Note that when the infrared light-emitting diode 21B outputs the infrared light rightward and when the infrared light-emitting diode 21C outputs the infrared light leftward, it suffices that the acquirer 32 acquires the first distribution information relating to the temperature distribution on the ceiling surface 101, and therefore, the process of acquiring the second distribution information relating to the temperature distribution on the floor surface 102 is omittable. Moreover, the acquirer 32 may acquire the distribution information in a state where the infrared light-emitting diodes 21B and 21C output the infrared light respectively rightward and leftward. In this case, the acquirer 32 can perform the acquisition process in one step.

Moreover, in FIG. 2, one lighting device 10A is installed on the ceiling surface 101 of the room 100, but a plurality of lighting devices 10A may be installed on the ceiling surface 101 of the room 100. In this case, the detection system 1 can perform the detection process for each of the plurality of lighting devices 10A, thereby detecting the attachment position information relating to the attachment position and the attachment direction information relating to the attachment direction of each of the plurality of lighting devices 10A.

### (3) Variations

The embodiment described above is a mere example of various embodiments of the present disclosure. The embodiment described above may be modified variously depending on design or the like as long as the object of the present disclosure is achieved.

Variations of the embodiment will be enumerated below. Any of the variations to be described below may be combined as appropriate. Moreover, the embodiment may be referred to as a basic configuration in the following description.

A function similar to the detection system 1 may be implemented by, for example, a detection method, a computer program, or a non-transitory recording medium including a program stored therein. The detection method according to an aspect includes an energy emitting process, the acquisition process, and the detection process. The energy emitting process includes causing the energy emitting unit to output the electromagnetic wave energy including at least one of light or heat from the attachment position of the environment control device 10 in the predetermined direction. The environment control device 10 is installed on the ceiling surface 101 of the room 100 to control the environment in the interior space 103 of the room 100. The acquisition process includes acquiring the distribution information including at least one of the first distribution information relating to the electromagnetic field intensity distribution on the ceiling surface 101 of the room 100 or the second distribution information relating to the electromagnetic field intensity distribution on the floor surface 102 of the room 100. The detection process includes detecting, based on the distribution information acquired in the acquisition process, the attachment position information relating to the attachment position of the environment control device 10 on the ceiling surface 101. The (computer) program according to an aspect is a program for causing a computer system to execute the detection method.

A subject which carries out the detection system 1 and detection method in the present disclosure includes a computer system. The computer system may include a processor and a memory element as principal hardware components thereof. The processor executes a program stored in the memory element of the computer system, thereby implementing a function as the subject, which carries out the detection system 1 and detection method in the present disclosure. The program may be stored in advance in the memory of the computer system. Alternatively, the program may also be downloaded over a telecommunications network or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be integrated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Moreover, in the description described above, the plurality of functions of the detection system 1 are integrated together in a single housing. However, this is only an example and is not an essential configuration for the detection system 1. Alternatively, these components of the detection system 1 may be distributed in multiple different housings. Further, at least some of the functions of the detection system 1, for example, some functions of the detector 33, may be implemented by, for example, cloud computing.

Conversely, in the first embodiment, at least some of the functions of the detection system 1 distributed in a plurality of devices may be integrated together in a single housing. For example, the detection device 30 and the sensor unit 40 may be integrated together in a single housing.

In the embodiment, the plurality of temperature sensors 41 are disposed on the ceiling surface 101 and the floor surface 102, but the plurality of temperature sensors 41 do not have to be fixed to the ceiling surface 101 and the floor surface 102. To detect the attachment position information and attachment direction information on the lighting device 10A, the plurality of temperature sensors 41 may temporarily be disposed on the ceiling surface 101 and the floor surface 102.

In the embodiment, the energy emitting unit 20 is housed in the housing 110 of the lighting device 10A, which is the environment control device 10, but the energy emitting unit 20 may attachably and detachably provided for the housing 110 of the environment control device 10.

### (3.1) First Variation

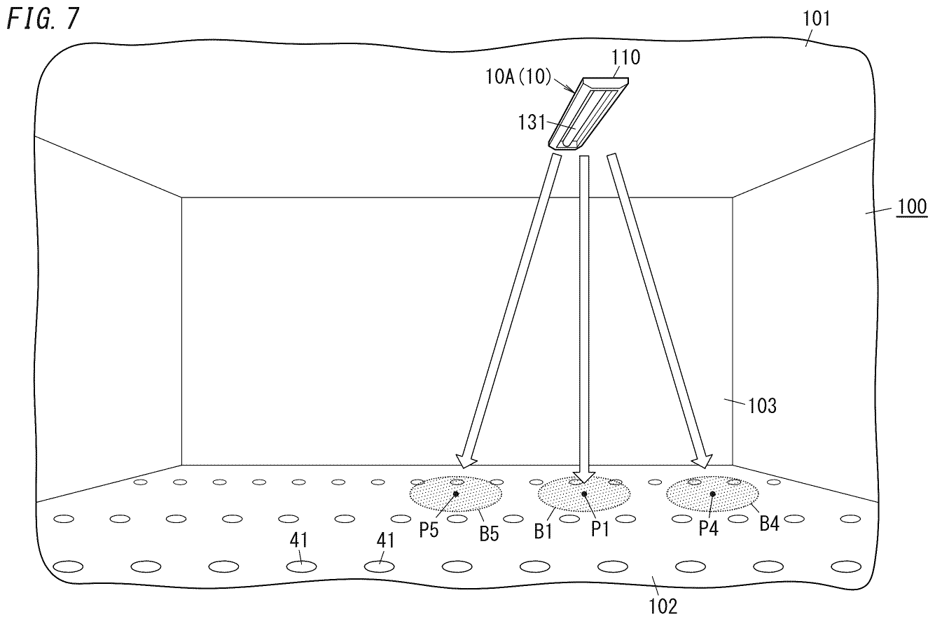

Based on FIG. 7, a detection system 1 according to a first variation will be described.

The detection system 1 of the first variation is different from the detection system of the basic configuration in that the energy emitting unit 20 is capable of selectively outputting electromagnetic wave energy vertically downward, obliquely down to the right, or obliquely down to the left.

The energy emitting unit 20 includes, for example, an infrared light-emitting diode capable of outputting infrared light which is an electromagnetic wave with heat radiation. More specifically, the energy emitting unit 20 includes, for example, an infrared light-emitting diode capable of outputting infrared light vertically downward from the environment control device 10, an infrared light-emitting diode capable of outputting infrared light obliquely down to the right from the environment control device 10, and an infrared light-emitting diode capable of outputting infrared light obliquely down to the left from the environment control device 10. Here, an angle formed between an optical axis of the infrared light-emitting diode capable of outputting the infrared light obliquely down to the right and the gravity direction and an angle formed between an optical axis of the infrared light-emitting diode capable of outputting the infrared light obliquely down to the left and the gravity direction are set to be the same angle. Note that saying that two angles are the same in the present embodiment is not limited to the two angles being exactly the same but may include two angles being different from each other by several degrees.

When the energy emitting unit 20 selectively outputs infrared light vertically downward, obliquely down to the right, or obliquely down to the left, it suffices that the plurality of temperature sensors 41 are installed on only the floor surface 102 and that the acquirer 32 acquires only the second distribution information relating to the electromagnetic field intensity distribution on the floor surface 102 of the room 100. Note that components common to the detection system 1 of the basic configuration are denoted by the same reference signs, and the description thereof is omitted.

To detect the attachment position of the lighting device 10A by the detection system 1 of the first variation, the energy emitting unit 20 outputs the infrared light vertically downward.

In the state where the energy emitting unit 20 outputs the infrared light downward, the acquirer 32 acquires the sensing results from the plurality of temperature sensors 41. The acquirer 32 acquires, based on the sensing results acquired from the plurality of temperature sensors 41, the second distribution information relating to the temperature distribution on the floor surface 102.

When the acquisition process by the acquirer 32 ends, the detector 33 performs, based on the second distribution information acquired by the acquirer 32, the process of detecting the attachment position information relating to the attachment position of the lighting device 10A. The detector 33 determines, from the second distribution information acquired by the acquirer 32, a region B1 (see FIG. 7) which is part of the floor surface 102 and which is irradiated with the infrared light, and the detector 33 determines a center position of the region B1 as a position P1 directly under the lighting device 10A. Then, the detector 33 determines a position coordinate of a position which is on the ceiling surface 101 and which is directly above the position P1 as the attachment position information relating to the attachment position of the lighting device 10A.

Further, to detect the attachment position information and attachment direction information on the lighting device 10A by the detection system 1 of the first variation, the energy emitting unit 20 outputs the infrared light obliquely down to the right and obliquely down to the left one at a time.

First of all, the user gives, to the operation unit 13 of the environment control device 10, a switching operation of causing the infrared light to be output obliquely down to the right, and the operation unit 13 then receives the switching operation given by the user, and the control unit 11 causes, based on the switching signal from the operation unit 13, the energy emitting unit 20 to output the infrared light obliquely down to the right. In the state where the energy emitting unit 20 outputs the infrared light obliquely down to the right, the user gives an operation to the operation unit 35 to instruct the acquisition process, and the acquirer 32 then acquires the sensing results from the plurality of temperature sensors 41. The acquirer 32 acquires, based on the sensing results acquired from the plurality of temperature sensors 41, the second distribution information relating to the temperature distribution on the floor surface 102.

Then, the user gives, to the operation unit 13 of the environment control device 10, a switching operation of causing the infrared light to be output obliquely down to the left, and the operation unit 13 then receives the switching operation given by the user, and the control unit 11 causes, based on the switching signal from the operation unit 13, the energy emitting unit 20 to output the infrared light obliquely down to the left. In the state where the energy emitting unit 20 outputs the infrared light obliquely down to the left, the user gives an operation to the operation unit 35 to instruct the acquisition process, and the acquirer 32 then acquires the sensing results from the plurality of temperature sensors 41. The acquirer 32 acquires, based on the sensing results acquired from the plurality of temperature sensors 41, the second distribution information relating to the temperature distribution on the floor surface 102.

When the acquirer 32 acquires the second distribution information in each of the state where the energy emitting unit 20 outputs the infrared light obliquely down to the right and the state where the energy emitting unit 20 outputs the infrared light obliquely down to the left, the detector 33 performs, based on the second distribution information acquired by the acquirer 32, the process of detecting the attachment position information relating to the attachment position and the attachment direction information relating to the attachment direction of the lighting device 10A. First of all, the detector 33 determines, based on the second distribution information in the state where the energy emitting unit 20 outputs the infrared light obliquely down to the right, a position coordinate of a center position P4 (see FIG. 7) of a region B4 which is part of the floor surface 102 and which is irradiated with the infrared light from the energy emitting unit 20. Then, the detector 33 determines, based on the second distribution information in the state where the energy emitting unit 20 outputs the infrared light obliquely down to the left, a position coordinate of a center position P5 (see FIG. 7) of a region B5 which is part of the floor surface 102 and which is irradiated with the infrared light from the energy emitting unit 20. Here, an angle formed between an optical axis of the infrared light-emitting diode capable of outputting the infrared light obliquely down to the right and the gravity direction and an angle formed between an optical axis of the infrared light-emitting diode capable of outputting the infrared light obliquely down to the left and the gravity direction are the same angle, and therefore, the two regions B4 and B5 are regions symmetric to a straight line passing through a position directly under the center position of the lighting device 10A and parallel to the long axis direction of the lighting device 10A.

Therefore, after determining the position coordinates of the center positions P4 and P5 respectively of the regions B4 and B5, the detector 33 calculates a position coordinate of a midpoint between the two center positions P4 and P5 to determine a position coordinate of a position which is on the ceiling surface 101 and which is directly above the midpoint between the center positions P4 and P5 as the position information relating to the attachment position of the lighting device 10A. Moreover, the detector 33 determines a straight line orthogonal to: a line segment passing through the midpoint between the center positions P4 and P5 and connecting the center positions P4 and P5 to each other; and a normal to the floor surface 102, and the detector 33 determines a direction extending along a straight line which is on the ceiling surface 101 and which is parallel to the above-determined straight line orthogonal to the line segment and the normal as the attachment direction information relating to the attachment direction of the housing 110.

As described above, also in the detection system 1 of the first variation, the detector 33 can detect the attachment position information relating to the attachment position of the lighting device 10A and the attachment direction information relating to the attachment direction of the lighting device 10A.

Note that in the first variation, the plurality of temperature sensors 41 are disposed on the floor surface 102, but the plurality of temperature sensors 41 do not have to be fixed to the floor surface 102. To detect the attachment position information and attachment direction information on the lighting device 10A, the plurality of temperature sensors 41 may temporarily be disposed on the floor surface 102.

### (3.2) Second Variation

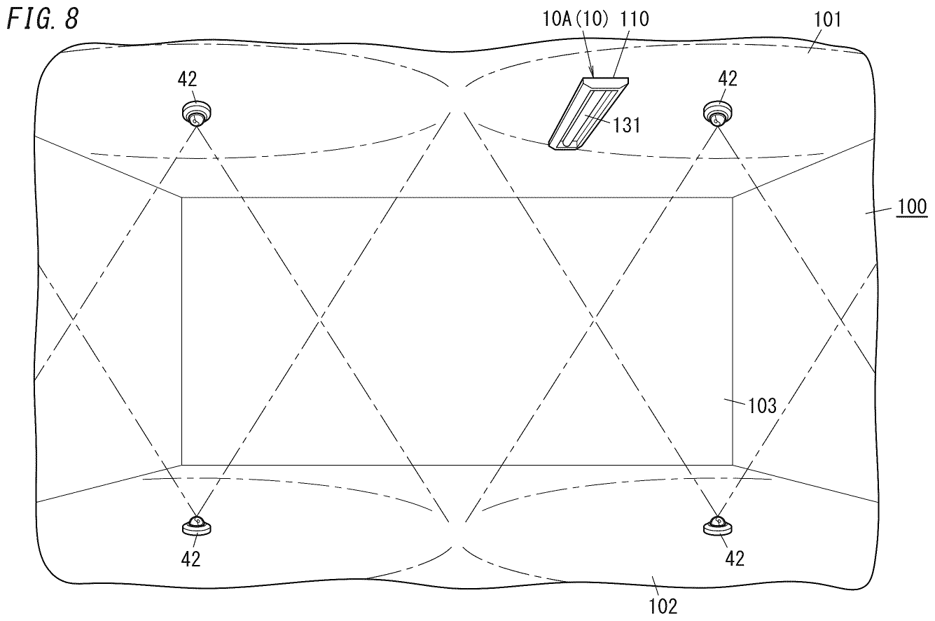

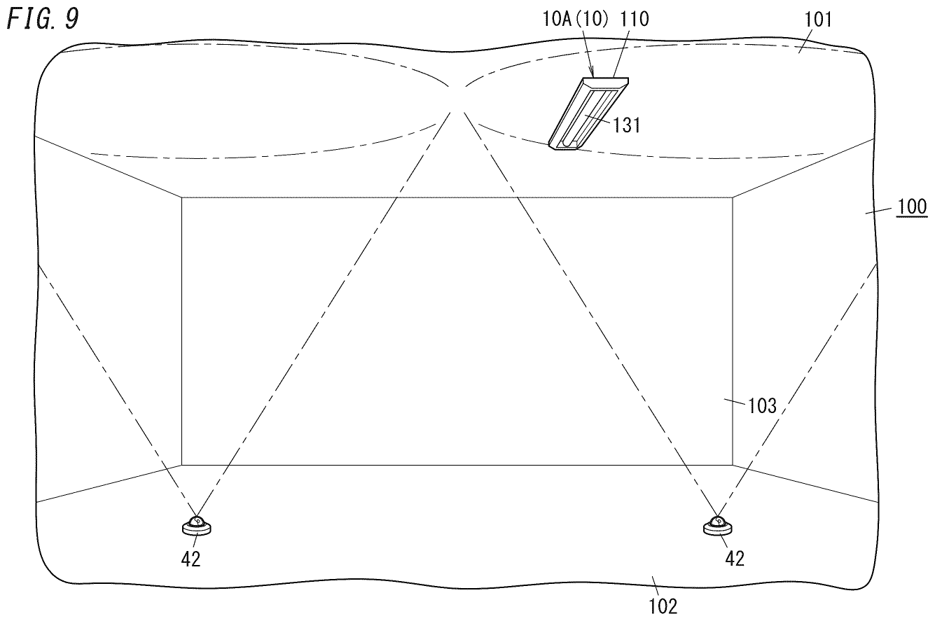

Based on FIGS. 8 and 9, a detection system 1 according to a second variation will be described.

The detection system 1 of the second variation is different from the detection system 1 of the basic configuration and the first variation in that the sensor unit 40 includes a plurality of infrared imaging cameras 42 disposed on the ceiling surface 101 and the floor surface 102.

Each of the plurality of infrared imaging cameras 42 disposed on the ceiling surface 101 includes an infrared imager sensitive to light in the infrared region and captures an infrared image of the floor surface 102. Each of the plurality of infrared imaging cameras 42 disposed on the floor surface 102 captures an infrared image of the ceiling surface 101.

Therefore, the acquirer 32 can acquire, based on the images captured by the plurality of infrared imaging cameras 42 disposed on the ceiling surface 101, the second distribution information relating to the electromagnetic field intensity distribution (e.g., the temperature distribution) on the floor surface 102. Moreover, the acquirer 32 can acquire, based on the images captured by the plurality of infrared imaging cameras 42 disposed on the floor surface 102, the first distribution information relating to the electromagnetic field intensity distribution (e.g., temperature distribution) on the ceiling surface 101.

Therefore, the detector 33 can detect, based on the first distribution information and the second distribution information acquired by the acquirer 32, at least one of the attachment position information relating to the attachment position or the attachment direction information relating to the attachment direction of the environment control device 10 (e.g., lighting device 10A).

Note that when the energy emitting unit 20 outputs the electromagnetic wave energy only downward, the infrared imaging cameras 42 for capturing the infrared images of the ceiling surface 101 are unnecessary, and it suffices that only the infrared imaging cameras 42 for capturing images of the floor surface 102 are installed on the ceiling surface 101.

Moreover, it is not essential that the infrared imaging cameras 42 for capturing the infrared images of the ceiling surface 101 and the floor surface 102 are fixed respectively to the floor surface 102 and the ceiling surface 101. The infrared imaging cameras 42 may temporarily be disposed to detect the attachment position information and attachment direction information on the lighting device 10A.

Thus, in the detection system 1 of the second variation, the acquirer 32 acquires, based on images captured by the infrared imagers sensitive to light in the infrared region, the distribution information on at least one of the ceiling surface 101 or the floor surface 102. Since the acquirer 32 acquires the distribution information on the basis of the images captured by the infrared imagers, the acquirer 32 can easily perform the process of acquiring the distribution information as compared with the case where the distribution information is acquired based on the sensing results by the plurality of temperature sensors 41.

Note that in the detection system 1 of the second variation, the plurality of infrared imaging cameras 42 are installed on the ceiling surface 101, but as long as an image of a region which is part of the floor surface 102 and to which the electromagnetic wave energy from the energy emitting unit 20 is output can be captured by a single infrared imaging camera 42, the number of the infrared imaging camera 42 disposed on the ceiling surface 101 may be one. Similarly, in the detection system 1 of the second variation, the plurality of infrared imaging cameras 42 are installed on the floor surface 102, but as long as an image of a region which is part of the ceiling surface 101 and to which the electromagnetic wave energy from the energy emitting unit 20 is output can be captured by a single infrared imaging camera 42, the number of the infrared imaging camera 42 disposed on the floor surface 102 may be one.

Note that in the detection system 1 of the second variation, the sensor unit 40 includes the plurality of infrared imaging cameras 42, but the sensor unit 40 is not limited to a unit including the infrared imaging cameras 42. The sensor unit 40 may include, for example, an infrared detection sensor, such as an infrared array sensor, capable of detecting a distribution of light in the infrared region on the ceiling surface 101 or the floor surface 102.

That is, the acquirer 32 may acquire the distribution information on the basis of the sensing results by the plurality of infrared detection sensors disposed on at least one of the ceiling surface 101 or the floor surface 102. Each of the plurality of infrared detection sensors receives light in the infrared region and outputs an electric signal according to the quantity of the light thus received. Since the acquirer 32 acquires the distribution information on the basis of the sensing results by the plurality of infrared detection sensors disposed on at least one of the ceiling surface 101 or the floor surface 102, the advantage that the sensor unit 40 can be embodied at low cost as compared with the case of employing the infrared imaging cameras 42 is provided.

### (3.3) Third Variation

A detection system 1 of a third variation is different from the basic configuration and the first and second variations in that the energy emitting unit 20 outputs light in the visible light region as the electromagnetic wave energy. That is, in the detection system 1 of the third variation, the energy emitting unit 20 includes, for example, a light-emitting diode that outputs light in the visible light region, and the energy emitting unit 20 is capable of outputting visible light in the predetermined direction. In the detection system 1 of the third variation, the acquirer 32 acquires the distribution information on the basis of sensing results by a plurality of visible-light sensors disposed on at least one of the ceiling surface 101 or the floor surface 102. Each of the plurality of visible-light sensors receives light in the visible light region and outputs an electric signal according to the quantity of the light thus received. Each of the plurality of visible-light sensors is embodied by, for example, a light-receiving diode sensitive to light in the visible light region.

In a similar manner to the basic configuration and the first and second variations, also in the detection system 1 of the third variation, the acquirer 32 acquires first distribution information indicating a distribution of light in the visible light region on the ceiling surface 101 and second distribution information indicating a distribution of light in the visible light region on the floor surface 102 in a state where the energy emitting unit 20 outputs the visible light in the predetermined direction.

Then, the detector 33 detects, based on the distribution information (the first distribution information and the second distribution information) acquired by the acquirer 32, the attachment position information relating to the attachment position of the lighting device 10A and the attachment direction information relating to the attachment direction of the lighting device 10A. A method of determining the attachment position and attachment direction of the lighting device 10A by the detector 33 is similar to the method described in the basic configuration and the first and second variations, and therefore, the description thereof is omitted.

Note that when the energy emitting unit 20 outputs the visible light in the predetermined direction, the acquirer 32 preferably acquires the distribution information on the basis of the output of the visible-light sensor in a state where an opening, such as a window, of the room 100 is closed with, for example, a curtain or blinds, and the lighting device disposed in the room 100 is off.

Moreover, when the environment control device 10 is the lighting device 10A, the energy emitting unit 20, which outputs the visible light in the predetermined direction, may serve also as the light source 131 of the lighting device 10A.

Moreover, in the third variation, the sensor unit 40 is not limited to a unit including the plurality of visible-light sensors but may be a visible imager sensitive to light in the visible light region and capable of capturing a visible light image on at least one of the ceiling surface 101 or the floor surface 102. That is, the acquirer 32 may acquire the distribution information on the basis of an image captured by a visible imager sensitive to light in the visible light region on at least one of the ceiling surface 101 or the floor surface 102. As compared with the case where the acquirer 32 acquires the distribution information on the basis of the output signals of the plurality of visible-light sensors, the process of acquiring the distribution information can be easily performed in the case where the distribution information is acquired from the image captured by the visible imager.

### (3.4) Fourth Variation

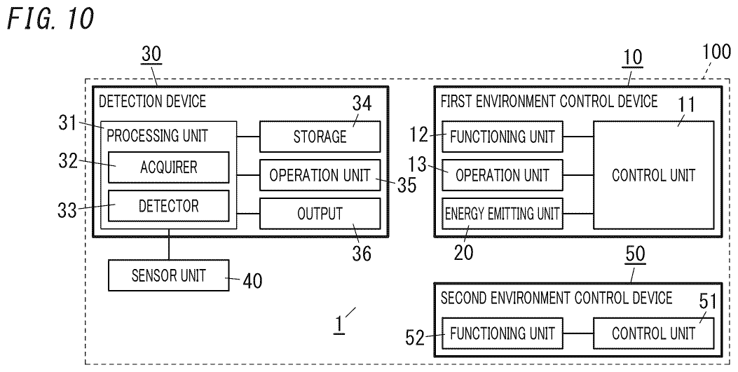

Based on FIG. 10, a detection system 1 according to a fourth variation will be described.

When the environment control device 10 described in the basic configuration and the first to third variations is assumed to be a first environment control device, the detection system 1 of the fourth variation includes a second environment control device 50 besides the first environment control device 10. The second environment control device 50 controls the environment in the interior space 103 of the room 100. The acquirer 32 acquires the distribution information in a state where the second environment control device 50 performs control such that the interior space 103 of the room 100 is in a predetermined state. Note that the detection system 1 of the fourth variation is similar to the detection system 1 described in the basic configuration and the first to third variations except that the detection system 1 of the fourth variation includes the second environment control device 50. Therefore, components common to those in the basic aspect and the first to third variations are denoted by the same reference signs, and the description thereof is omitted.

The second environment control device 50 includes a functioning unit 52 for controlling the environment in the interior space 103 of the room 100 and a control unit 51 for controlling the functioning unit 52.

When the energy emitting unit 20 outputs the electromagnetic wave with heat radiation, the second environment control device 50 is preferably, for example, an air conditioning device that adjusts the temperature of the interior space 103 of the room 100, and it suffices that the functioning unit 52 has the function of adjusting the temperature of the interior space 103 of the room 100.

In the detection system 1 of the fourth variation, when the acquirer 32 acquires the distribution information, the air conditioning device, which is the second environment control device 50, performs cooling operation such that the interior space of the room 100 has a second temperature lower than a first temperature which is a temperature when the air conditioning device is off. In this state, the energy emitting unit 20 outputs the electromagnetic wave with heat radiation in the predetermined direction, and the acquirer 32 acquires the distribution information.

As described above, since the energy emitting unit 20 outputs the electromagnetic wave with heat radiation in the state where the second environment control device 50 performs control such that the interior space 103 of the room 100 has the second temperature lower than the first temperature, the acquirer 32 can easily detect a region irradiated with the electromagnetic wave with heat radiation from the energy emitting unit 20 and can more accurately detect the attachment position information and attachment direction information on the first environment control device 10.

Note that the second environment control device 50 is not limited to the air conditioning device, but a control target of the second environment control device 50 may accordingly be changed depending on the electromagnetic wave energy output from the energy emitting unit 20. For example, when the energy emitting unit 20 outputs visible light, it suffices that the second environment control device 50 has a function of controlling the brightness in the interior space 103 of the room 100. For example, it suffices that the functioning unit 52 of the second environment control device 50 has a function of electrically opening and closing, for example, the curtain or blinds installed at the window of the room 100. In this case, it suffices that the acquirer 32 acquires the distribution information in a state where the window is covered with, for example, the curtain or the blinds electrically driven by the functioning unit 52 of the second environment control device 50, which facilitates detection of the region which is part of the ceiling surface 101 or the floor surface 102 and which is irradiated with the visible light from the energy emitting unit 20.

### (3.5) Fifth Variation

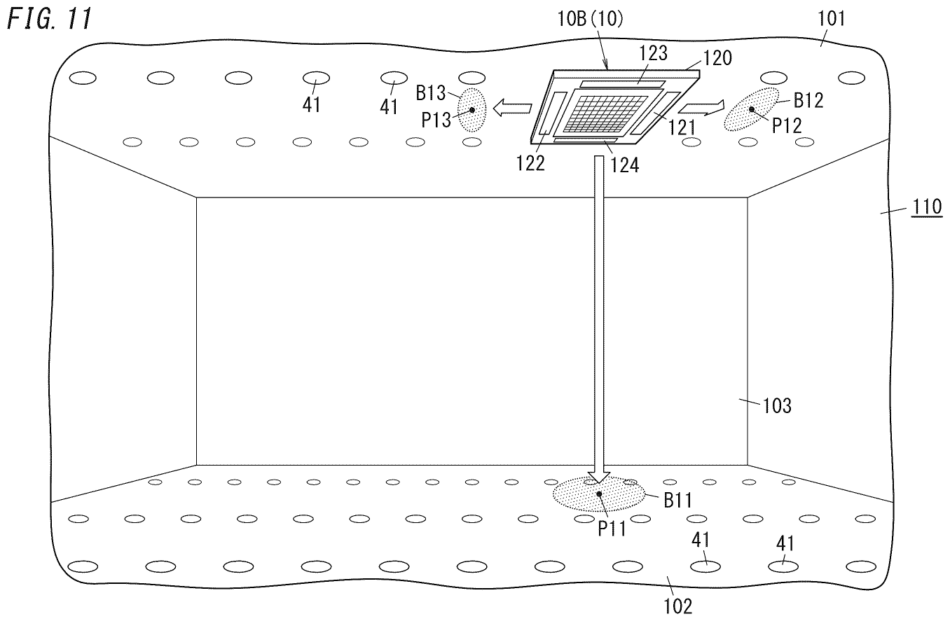

Based on FIGS. 11 to 14, a detection system 1 according to a fifth variation will be described.

The detection system 1 according to the fifth variation is different from the basic configuration and the first to fourth variations in that the environment control device 10 is an air conditioning device 10B installed on the ceiling surface 101. The air conditioning device 10B has a configuration similar to that of the lighting device 10A except that a functioning unit 12 of the air conditioning device 10B provides a function different from that of the functioning unit 12 of the lighting device 10A, and therefore, components common to those of the lighting device 10A are denoted by the same reference signs, and the description thereof is omitted.

The air conditioning device 10B includes the functioning unit 12 providing a function of blowing warm air or cold air. The functioning unit 12 of the air conditioning device 10B includes, for example, a heat exchanger for warming or cooling air and a blast fan for producing airflow. Moreover, the air conditioning device 10B includes a housing 120 which is fixed to the ceiling surface 101 while the housing 120 is partially embedded in the ceiling surface 101. The housing 120 has a substantially square shape when viewed from below and has air ventilation ports 121 to 124 along four sides of the housing 120. Moreover, the air conditioning device 10B has louvers for controlling the direction of air blown out through the respective four ventilation ports 121 to 124. Note that a reference direction of the housing 120 of the air conditioning device 10B is, for example, a direction parallel to two sides on which the ventilation ports 121 and 122 are provided.

Here, the air conditioning device 10B, which is the environment control device 10, includes an energy emitting unit 20 capable of outputting airflow at a predetermined temperature in the predetermined direction. For that matter, the functioning unit 12 of the air conditioning device 10B serves also as the energy emitting unit 20, and the acquirer 32 performs the acquisition process in a state where the air conditioning device 10B outputs airflow at a second temperature or airflow at a third temperature. The second temperature is a temperature lower by a predetermined degree than the first temperature of the interior space 103 in a state where the air conditioning device 10B is off. The third temperature is a temperature higher by the predetermined degree than the first temperature. Since the energy emitting unit 20 is embodied by the functioning unit 12 of the air conditioning device 10B, and the energy emitting unit 20 is used also as the functioning unit 12, there is the advantage that the energy emitting unit 20 does not have to be provided besides the functioning unit 12.

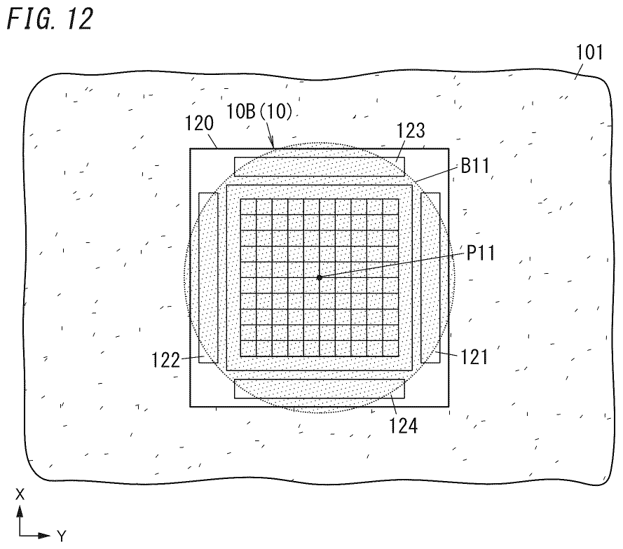

The air conditioning device 10B is capable of outputting the airflow at the predetermined temperature (the second temperature or the third temperature) in the predetermined direction. For example, the air conditioning device 10B can output the airflow at the predetermined temperature vertically downward from the four ventilation ports 121 to 124. The airflow at the predetermined temperature output vertically downward from the air conditioning device 10B is output to a region B11 in the shape of an ellipse with the center of the ellipse corresponding to the center of the housing 120 (see FIGS. 11 and 12).

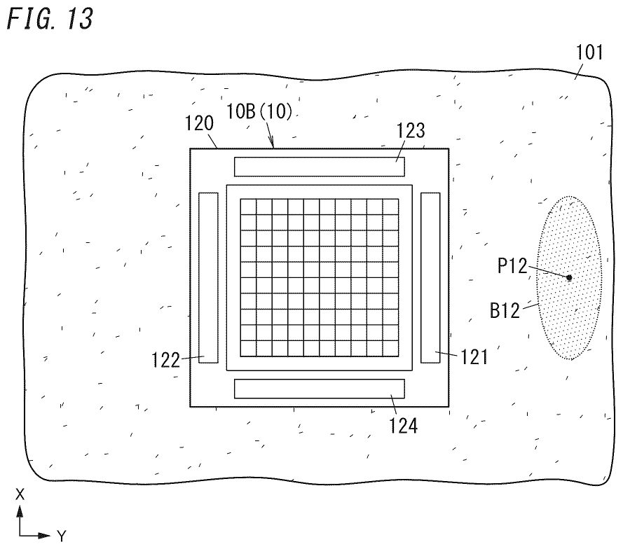

Moreover, when the airflow at the predetermined temperature is output rightward from the ventilation port 121 along the right side of the air conditioning device 10B, the airflow output from the ventilation port 121 is output to a region B12 (see FIGS. 11 and 13) which is part of the ceiling surface 101 and which is on a right side of the housing 120. Here, a center position P12 of the region B12 is located on the right side of the center position of the housing 120. Note that the center position of the housing 120 is a center position on a lower surface of the housing 120 and is a center position in the left/right direction and the front/rear direction.

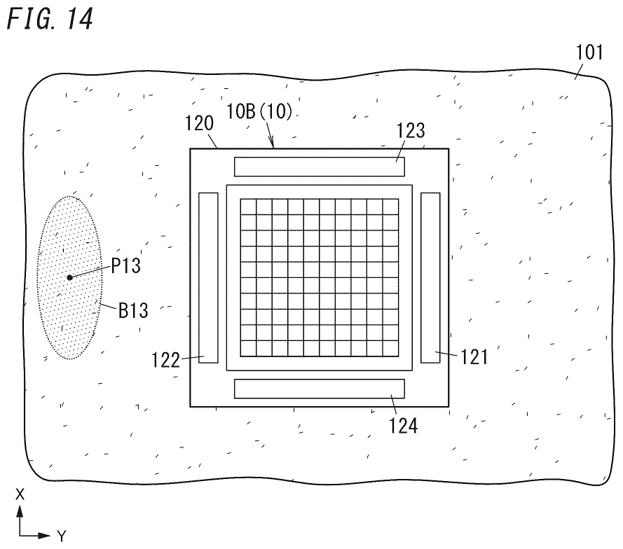

Moreover, when the airflow at the predetermined temperature is output leftward from the ventilation port 122 along the left side of the air conditioning device 10B, the airflow output from the ventilation port 122 is output to a region B13 (see FIGS. 11 and 14) which is part of the ceiling surface 101 and which is on the left side of the housing 120. A center position P13 of the region B13 is located on the left side of the center position of the housing 120.

Here, a ventilation direction when the air conditioning device 10B blows airflow rightward from the ventilation port 121 and a ventilation direction when the air conditioning device 10B blows airflow leftward from the ventilation port 122 are directed to opposite directions of the center position of the air conditioning device 10B from each other. Therefore, the region B12 hit by the airflow output rightward from the air conditioning device 10B and the region B13 hit by the airflow output leftward from the air conditioning device 10B are regions symmetric to a straight line which passes through the center position of the housing 120 and which is parallel to the reference direction of the housing 120.

Here, to detect the attachment position of the air conditioning device 10B by the detection system 1 of the fifth variation, the user gives an operation to an operation unit 13 of the air conditioning device 10B to cause the air conditioning device 10B to output the airflow at the predetermined temperature vertically downward. In the state where the air conditioning device 10B outputs the airflow at the predetermined temperature vertically downward, the acquirer 32 acquires the sensing results from the plurality of temperature sensors 41 installed on the floor surface 102. The acquirer 32 acquires, based on the sensing results acquired from the plurality of temperature sensors 41 installed on the floor surface 102, the temperature distribution on the floor surface 102 as the second distribution information.

When the acquisition process by the acquirer 32 ends, the detector 33 performs, based on the second distribution information acquired by the acquirer 32, a process of detecting attachment position information relating to the attachment position of the air conditioning device 10B. The detector 33 determines, from the second distribution information acquired by the acquirer 32, the region B11 (see FIGS. 11 and 12), which is part of the floor surface 102 and which is hit by the airflow at the predetermined temperature, and the detector 33 determines the center position of the region B11 as a position P11 directly under the air conditioning device 10B. Then, the detector 33 determines, on the ceiling surface 101, a position coordinate of a position directly above the position P11 as the attachment position information relating to the attachment position of the air conditioning device 10B.

Moreover, to detect the attachment position and the attachment direction of the air conditioning device 10B by the detection system 1 of the fifth variation, the acquirer 32 performs the acquisition process in each of a state where the air conditioning device 10B outputs the airflow at the predetermined temperature rightward and a state where the air conditioning device 10B outputs the airflow at the predetermined temperature leftward.

First of all, the user gives an operation to the operation unit 13 of the air conditioning device 10B, thereby causing the airflow at the predetermined temperature to be output rightward from the ventilation port 121 of the air conditioning device 10B. In the state where the air conditioning device 10B outputs the airflow at the predetermined temperature rightward from the ventilation port 121, the acquirer 32 acquires the sensing result from the plurality of temperature sensors 41 installed on the ceiling surface 101. The acquirer 32 acquires, based on the sensing results acquired from the plurality of temperature sensors 41 installed on the ceiling surface 101, the first distribution information relating to the temperature distribution on the ceiling surface 101.

Then, the user gives an operation to the operation unit 13 of the air conditioning device 10B, thereby causing the airflow at the predetermined temperature to be output leftward from the ventilation port 122 of the air conditioning device 10B. In the state where the air conditioning device 10B outputs the airflow at the predetermined temperature leftward from the ventilation port 122, the acquirer 32 acquires the sensing result from the plurality of temperature sensors 41 installed on the ceiling surface 101. The acquirer 32 acquires, based on the sensing results acquired from the plurality of temperature sensors 41 installed on the ceiling surface 101, the first distribution information relating to the temperature distribution on the ceiling surface 101.

When the acquirer 32 acquires the first distribution information in each of the state where the air conditioning device 10B outputs the airflow at the predetermined temperature rightward and the state where the air conditioning device 10B outputs the airflow at the predetermined temperature leftward, the detector 33 performs, based on the first distribution information acquired by the acquirer 32, the process of detecting the attachment position information relating to the attachment position and the attachment direction information relating to the attachment direction of the air conditioning device 10B. First of all, the detector 33 determines, based on the first distribution information in the state where the air conditioning device 10B outputs the airflow at the predetermined temperature rightward, a position coordinate of the center position P12 (see FIGS. 11 and 13) of the region B12, which is on the ceiling surface 101 and which is hit by the airflow at the predetermined temperature output from the air conditioning device 10B. Then, the detector 33 determines, based on the first distribution information in the state where the air conditioning device 10B outputs the airflow at the predetermined temperature leftward, a position coordinate of the center position P13 (see FIGS. 11 and 14) of the region B13, which is on the ceiling surface 101 and which is hit by the airflow at the predetermined temperature output from the air conditioning device 10B. Upon determining the position coordinates of the center positions P12 and P13 respectively of the regions B12 and B13, the detector 33 determines a position coordinate of a midpoint between the two center positions P12 and P13 as a position coordinate of the attachment position of the air conditioning device 10B. Moreover, the detector 33 determines a direction orthogonal to: a line segment passing through the midpoint between the two center positions P12 and P13 and connecting the two center positions P12 and P13 to each other; and a normal to the ceiling surface 101 as a direction (the attachment direction) in which the reference direction of the air conditioning device 10B is directed, and the detector 33 determines information (e.g., vector information) representing this direction as the attachment direction information.

As described above, also in the detection system 1 of the fifth variation, the detector 33 can detect the attachment position information relating to the attachment position of the air conditioning device 10B and the attachment direction information relating to the attachment direction of the air conditioning device 10B.

### (3.6) Sixth Variation

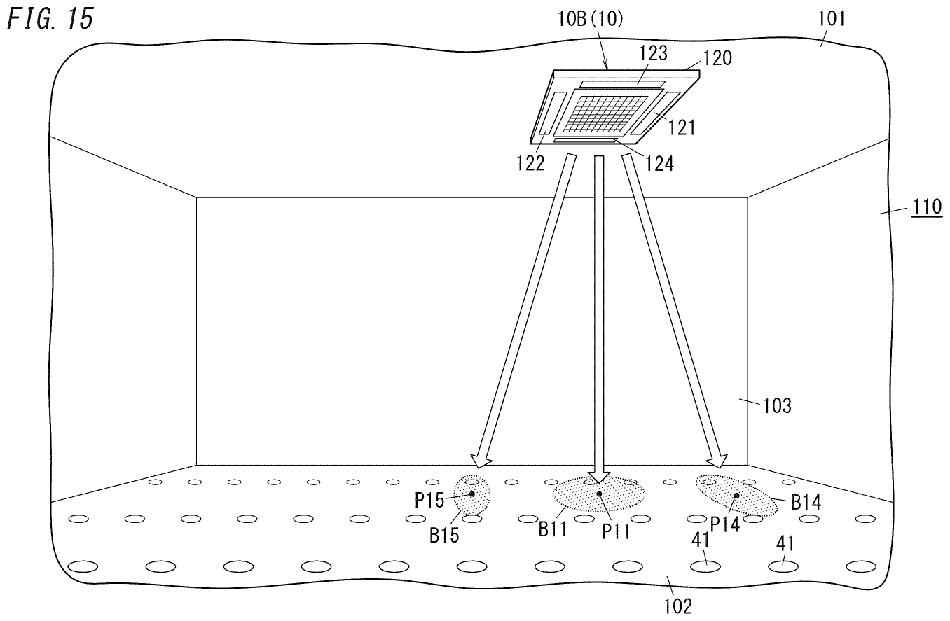

Based on FIG. 15, a detection system 1 according to a sixth variation will be described.

The detection system 1 according to the sixth variation is different from the fifth variation in that the acquirer 32 performs the acquisition process in each of a state where the air conditioning device 10B outputs the airflow at the predetermined temperature vertically downward, a state where the air conditioning device 10B outputs the airflow at the predetermined temperature obliquely down to the right, and a state where the air conditioning device 10B outputs the airflow at the predetermined temperature obliquely down to the left. Note that except for the directions in which the air conditioning device 10B outputs the airflow at the predetermined temperature when the acquirer 32 performs the acquisition process, the detection system 1 of the sixth variation is similar to the detection system 1 of the fifth variation, and thus, components common to those of the fifth variation are denoted by the same reference signs as those in the fifth variation, and the description thereof is omitted.

In the air conditioning device 10B of the sixth variation, the acquirer 32 performs the acquisition process in each of the state where the air conditioning device 10B outputs the airflow at the predetermined temperature vertically downward, the state where the air conditioning device 10B outputs the airflow at the predetermined temperature obliquely down to the right, and the state where the air conditioning device 10B outputs the airflow at the predetermined temperature obliquely down to the left as shown in FIG. 15, and based on the distribution information acquired by the acquirer 32, the detector 33 performs the detection process. Note that an angle formed between an air direction when the air conditioning device 10B outputs the airflow obliquely down to the right and the gravity direction and an angle formed between an air direction when the air conditioning device 10B outputs the airflow obliquely down to the left and the gravity direction are set to be the same angle.

Here, to detect the attachment position of the air conditioning device 10B by the detection system 1, the air conditioning device 10B outputs the airflow at the predetermined temperature vertically downward.

In the state where the air conditioning device 10B outputs the airflow at the predetermined temperature vertically downward, the acquirer 32 acquires the sensing results from the plurality of temperature sensors 41. The acquirer 32 acquires, based on the sensing results acquired from the plurality of temperature sensors 41, the second distribution information relating to the temperature distribution on the floor surface 102.

When the acquisition process by the acquirer 32 ends, the detector 33 performs, based on the second distribution information acquired by the acquirer 32, the process of detecting the attachment position information relating to the attachment position of the air conditioning device 10B. The detector 33 determines, from the second distribution information acquired by the acquirer 32, a region B11 which is part of the floor surface 102 and to which the airflow at the predetermined temperature is output, and the detector 33 determines a center position of the region B11 as a position P11 directly under the air conditioning device 10B. Note that the detector 33 determines a region in which a temperature is higher than or equal to a predetermined threshold temperature as the region B11, to which the airflow at the predetermined temperature is output. Then, the detector 33 determines a position coordinate of a position which is on the ceiling surface 101 and which is directly above the position P11 as the attachment position information relating to the attachment position of the air conditioning device 10B.

Moreover, to detect the attachment position information and the attachment direction information on the air conditioning device 10B by the detection system 1 of the sixth variation, the air conditioning device 10B outputs the airflow at the predetermined temperature obliquely down to the right and obliquely down to the left one at a time.

First of all, the user gives, to the operation unit 13 of the air conditioning device 10B, a switching operation of causing the airflow at the predetermined temperature to be output obliquely down to the right, and the operation unit 13 then receives the switching operation given by the user, and the control unit 11 causes, based on the switching signal from the operation unit 13, the air conditioning device 10B to output the airflow at the predetermined temperature obliquely down to the right. In the state where the air conditioning device 10B outputs the airflow at the predetermined temperature obliquely down to the right, the user gives an operation to the operation unit 35 to instruct the acquisition process, and the acquirer 32 then acquires the sensing results from the plurality of temperature sensors 41. The acquirer 32 acquires, based on the sensing results acquired from the plurality of temperature sensors 41, the second distribution information relating to the temperature distribution on the floor surface 102.

Then, the user gives, to the operation unit 13 of the air conditioning device 10B, a switching operation of causing the airflow at the predetermined temperature to be output obliquely down to the left, and the operation unit 13 then receives the switching operation given by the user, and the control unit 11 causes, based on the switching signal from the operation unit 13, the air conditioning device 10B to output the airflow at the predetermined temperature obliquely down to the left. In the state where the air conditioning device 10B outputs the airflow at the predetermined temperature obliquely down to the left, the user gives an operation to the operation unit 35 to instruct the acquisition process, and the acquirer 32 then acquires the sensing results from the plurality of temperature sensors 41. The acquirer 32 acquires, based on the sensing results acquired from the plurality of temperature sensors 41, the second distribution information relating to the temperature distribution on the floor surface 102.

When the acquirer 32 acquires the second distribution information in each of the state where the air conditioning device 10B outputs the airflow at the predetermined temperature obliquely down to the right and the state where the air conditioning device 10B outputs the airflow at the predetermined temperature obliquely down to the left, the detector 33 performs, based on the second distribution information acquired by the acquirer 32, the process of detecting the attachment position information relating to the attachment position and the attachment direction information relating to the attachment direction of the air conditioning device 10B.

First of all, the detector 33 determines, based on the second distribution information in the state where the air conditioning device 10B outputs the airflow at the predetermined temperature obliquely down to the right, a position coordinate of a center position P14 of a region B14 which is part of the floor surface 102 and which is hit by the airflow. Then, the detector 33 determines, based on the second distribution information in the state where the air conditioning device 10B outputs the airflow at the predetermined temperature obliquely down to the left, a position coordinate of a center position P15 of a region B15 which is part of the floor surface 102 and which is hit by the airflow.

Here, an angle formed between the air direction when the air conditioning device 10B outputs the airflow obliquely down to the right and the gravity direction and an angle formed between the air direction when the air conditioning device 10B outputs the airflow obliquely down to the left and the gravity direction are set to be the same angle. Therefore, the two regions B14 and B15 are regions symmetric to a straight line passing through a position directly under the center position of the air conditioning device 10B and parallel to the reference direction of the air conditioning device 10B.

Therefore, upon determining the position coordinates of the center positions P14 and P15 respectively of the regions B14 and B15, the detector 33 calculates a position coordinate of a midpoint between the two center positions P14 and P15 to determine a position coordinate of a position which is on the ceiling surface 101 and which is directly above the midpoint between the center positions P14 and P15 as the position information relating to the attachment position of the air conditioning device 10B. Moreover, the detector 33 determines a straight line orthogonal to: a line segment passing through the midpoint between the center positions P14 and P15 and connecting the center positions P14 and P15 to each other; and the normal to the floor surface 102, and the detector 33 determines a direction extending along a straight line which is on the ceiling surface 101 and which is parallel to the above-determined straight line orthogonal to the line segment and the normal as the attachment direction information on the attachment direction of the housing 120.

As described above, also in the detection system 1 of the sixth variation, the detector 33 can detect the attachment position information relating to the attachment position of the air conditioning device 10B and the attachment direction information relating to the attachment direction of the air conditioning device 10B.

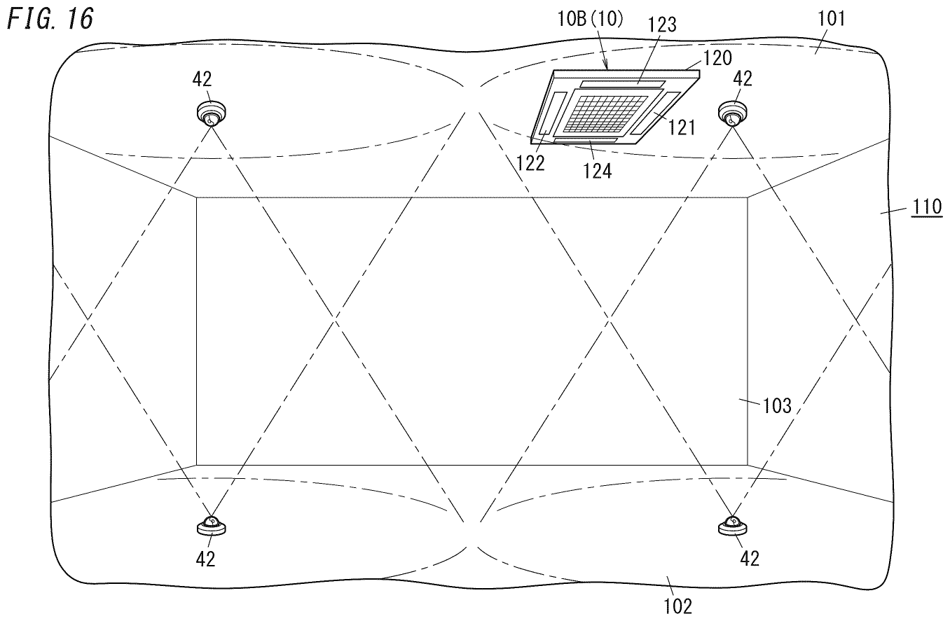

Note that in the fifth and sixth variations, the sensor unit 40 includes the plurality of temperature sensors 41, but the sensor unit 40 may include a plurality of infrared imaging cameras 42 disposed on the ceiling surface 101 and the floor surface 102 (see FIG. 16) in a similar manner to the second variation. That is, the acquirer 32 may acquire the distribution information on the basis of the sensing results by the plurality of infrared imaging cameras 42 disposed on the ceiling surface 101 and the floor surface 102.

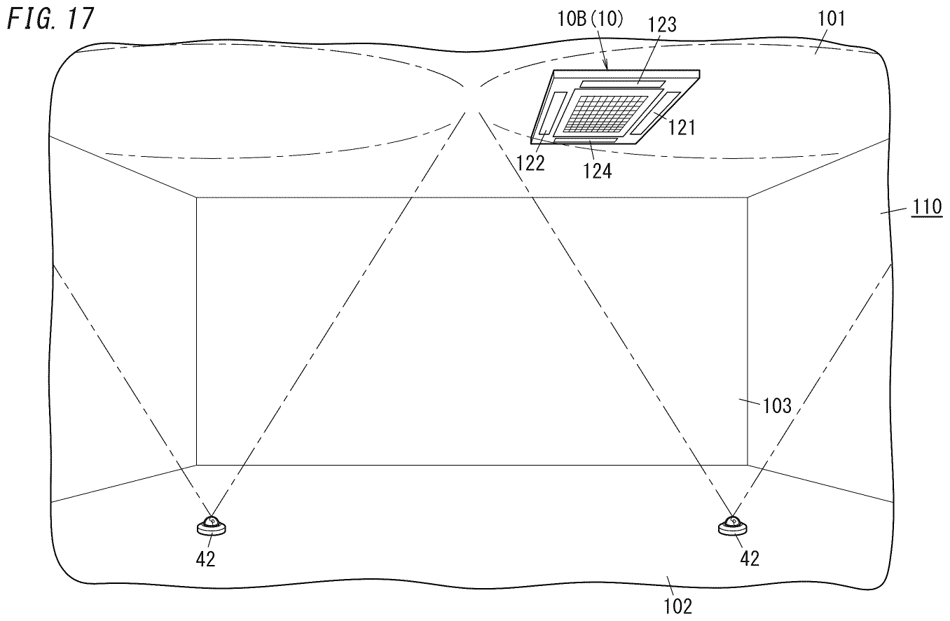

Moreover, when the detector 33 detects, based on the first distribution information on the ceiling surface 101, the attachment position information and the attachment direction information on the air conditioning device 10B, it suffices that the sensor unit 40 includes only the infrared imaging camera 42 which captures the ceiling surface 101 (see FIG. 17), and the infrared imaging camera 42 for capturing the floor surface 102 is omittable.

Moreover, in the fifth and sixth variations, the sensor unit 40 may include an infrared detection sensor, such as an infrared array sensor, capable of detecting a distribution of light in the infrared region on the ceiling surface 101 or floor surface 102.

That is, it suffices that the sensor unit 40 includes a sensor capable of detecting a region hit by the airflow at the predetermined temperature output from the air conditioning device 10B, and the configuration of the sensor unit 40 may accordingly be modified.

### Summary

The embodiment and the variations above disclose the following aspects.

A detection system (1) of a first aspect includes an environment control device (10), an energy emitting unit (20), an acquirer (32), and a detector (33). The environment control device (10) is configured to be installed on a ceiling surface (101) of a room (100) to control an environment in an interior space (103) of the room (100). The energy emitting unit (20) is capable of outputting electromagnetic wave energy including at least one of light or heat from an attachment position of the environment control device (10) in a predetermined direction. The acquirer (32) is configured to acquire distribution information including at least one of first distribution information relating to an electromagnetic field intensity distribution on the ceiling surface (101) of the room (100) or second distribution information relating to an electromagnetic field intensity distribution on a floor surface (102) of the room (100). The detector (33) is configured to detect, based on the distribution information acquired by the acquirer (32), attachment position information relating to the attachment position of the environment control device (10) on the ceiling surface (101).

This aspect enables the detection system (1) capable of detecting the attachment position information relating to the attachment position of the environment control device (10) to be provided.

In a detection system (1) of a second aspect referring to the first aspect, the detector (33) is configured to further detect attachment direction information relating to an attachment direction of the environment control device (10) on the ceiling surface (101).

With this aspect, further detecting the attachment direction information relating to the attachment direction of the environment control device (10) enables the attached state of the environment control device (10) to be detected in further detail.

In a detection system (1) of a third aspect referring to the first or second aspect, the environment control device (10) includes the energy emitting unit (20).

This aspect enables the labor of preparing the energy emitting unit (20) besides the environment control device (10) to be omitted.

In a detection system (1) of a fourth aspect referring to any one of the first to third aspects, the energy emitting unit (20) is capable of outputting an electromagnetic wave with heat radiation in the predetermined direction.

With this aspect, the electromagnetic wave with the heat radiation output from the energy emitting unit (20) can change at least one of the first distribution information or the second distribution information which are to be acquired by the acquirer (32), and the detector (33) can detect the attachment position information on the basis of the at least one of the first distribution information or the second distribution information.

In a detection system (1) of a fifth aspect referring to any one of the first to third aspects, the energy emitting unit (20) is capable of outputting airflow at a predetermined temperature in the predetermined direction.

With this aspect, the airflow at the predetermined temperature and output from the energy emitting unit (20) can change at least one of the first distribution information or the second distribution information which are to be acquired by the acquirer (32), and the detector (33) can detect the attachment position information on the basis of the at least one of the first distribution information or the second distribution information.

In a detection system (1) of a sixth aspect referring to the fourth or fifth aspect, the acquirer (32) is configured to acquire the distribution information on a basis of sensing results by a plurality of temperature sensors (41) disposed on at least one of the ceiling surface (101) or the floor surface (102). Each of the plurality of temperature sensors (41) is configured to detect an ambient temperature.

With this aspect, the acquirer (32) can acquire, based on the sensing results by the temperature sensors (41), a distribution of the electromagnetic wave energy output from the energy emitting unit (20).

In a detection system (1) of a seventh aspect referring to the fourth or fifth aspect, the acquirer (32) is configured to acquire the distribution information on a basis of sensing results by a plurality of infrared detection sensors disposed on at least one the ceiling surface (101) or the floor surface (102). Each of the plurality of infrared detection sensors is configured to receive light in an infrared region and output an electric signal according to a quantity of the light thus received.

With this aspect, the acquirer (32) can acquire, based on the sensing results by the infrared detection sensors, a distribution of the electromagnetic wave energy output from the energy emitting unit (20).

In a detection system (1) of an eighth aspect referring to the fourth or fifth aspect, the acquirer (32) is configured to acquire, based on an output from an infrared imager sensitive to light in an infrared region, the distribution information on at least one of the ceiling surface (101) or the floor surface (102).

With this aspect, the acquirer (32) can acquire, based on the output from the infrared imager, that is, an image captured by the infrared imager, a distribution of the electromagnetic wave energy output from the energy emitting unit (20).

In a detection system (1) of a ninth aspect referring to any one of the first to third aspects, the energy emitting unit (20) is capable of outputting visible light in the predetermined direction.

With this aspect, the visible light output from the energy emitting unit (20) can change at least one of the first distribution information or the second distribution information which are to be acquired by the acquirer (32), and the detector (33) can detect the attachment position information on the basis of the at least one of the first distribution information or the second distribution information.

In a detection system (1) of a tenth aspect referring to the ninth aspect, the acquirer (32) includes a plurality of visible-light sensors disposed on at least one of the ceiling surface (101) or the floor surface (102). Each of the plurality of visible-light sensors is configured to receive light in a visible light region and output an electric signal according to a quantity of the light thus received.

With this aspect, the acquirer (32) can acquire, based on the output from the visible-light sensor, the distribution information of the visible light output from the energy emitting unit (20).

In a detection system (1) of an eleventh aspect referring to the ninth aspect, the acquirer (32) includes a visible imager sensitive to light in a visible light region on at least one of the ceiling surface (101) or the floor surface (102).

With this aspect, the acquirer (32) can acquire, based on an output of the visible imager, that is, an image captured by the visible imager, the distribution information of the visible light output from the energy emitting unit (20).

In a detection system (1) of a twelfth aspect referring to any one of the first to eleventh aspects, the environment control device (10) is a first environment control device (10). The detection system (1) further includes a second environment control device (50) configured to control an environment in the interior space (103) of the room (100). The acquirer (32) is configured to acquire the distribution information in a state where the second environment control device (50) performs control such that the interior space (103) of the room (100) is in a predetermined state.

With this aspect, in the state where the second environment control device (50) performs control such that the interior space (103) of the room (100) is in the predetermined state, the acquirer (32) performs the acquisition process, and thus, there is the advantage that the distribution information of the electromagnetic wave energy output from the energy emitting unit (20) is easily detected.

A detection method of a twelfth aspect includes an energy emitting process, an acquisition process, and a detection process. The energy emitting process includes causing an energy emitting unit (20) to output electromagnetic wave energy including at least one of light or heat from an attachment position of an environment control device (10) in a predetermined direction. The environment control device (10) is configured to be installed on a ceiling surface (101) of a room (100) to control an environment in an interior space (103) of the room (100). The acquisition process includes acquiring distribution information including at least one of first distribution information relating to an electromagnetic field intensity distribution on the ceiling surface (101) of the room (100) or second distribution information relating to an electromagnetic field intensity distribution on a floor surface (102) of the room (100). The detection process includes detecting, based on the distribution information acquired in the acquisition process, attachment position information relating to the attachment position of the environment control device (10) on the ceiling surface (101).

This aspect enables the attachment position information relating to the attachment position of the environment control device (10) to be detected.

The various configurations (including the variations) of the detection system (1) according to the first and second embodiments described above are not limited to the aspect but are implementable by, for example, a detection method of the detection system (1), a (computer) program, or non-transitory recording medium storing a program.

The configurations according to the second to eleventh aspects are not configurations essential for the detection system (1) and may accordingly be omitted.

### REFERENCE SIGNS LIST

1 Detection System
10 Environment Control Device (First Environment Control Device)
20 Energy Emitting Unit
32 Acquirer
33 Detector
50 Second Environment Control Device
100 Room
101 Ceiling Surface
102 Floor Surface
103 Interior Space
41 Temperature Sensor

1. A detection system comprising:
an environment control device is configured to be installed on a ceiling surface of a room to control an environment in an interior space of the room;
an energy emitting unit capable of outputting electromagnetic wave energy including at least one of light or heat from an attachment position of the environment control device in a predetermined direction;
an acquirer configured to acquire distribution information including at least one of first distribution information relating to an electromagnetic field intensity distribution on the ceiling surface of the room or second distribution information relating to an electromagnetic field intensity distribution on a floor surface of the room; and
a detector configured to detect, based on the distribution information acquired by the acquirer, attachment position information relating to the attachment position of the environment control device on the ceiling surface.

212. The detection system of claim 1, wherein
the detector is configured to further detect attachment direction information relating to an attachment direction of the environment control device on the ceiling surface.

3. The detection system of claim 1, wherein
the environment control device includes the energy emitting unit

4. The detection system of claim 1, wherein
the energy emitting unit is capable of outputting an electromagnetic wave with heat radiation in the predetermined direction.

5. The detection system of claim 1, wherein
the energy emitting unit is capable of outputting airflow at a predetermined temperature in the predetermined direction.

6. The detection system of claim 4, wherein
the acquirer is configured to acquire the distribution information on a basis of sensing results by a plurality of temperature sensors disposed on at least one of the ceiling surface or the floor surface, and
each of the plurality of temperature sensors is configured to detect an ambient temperature.

7. The detection system of claim 4, wherein
the acquirer is configured to acquire the distribution information on a basis of sensing results by a plurality of infrared detection sensors disposed on at least one of the ceiling surface or the floor surface,
each of the plurality of infrared detection sensors is configured to receive light in an infrared region and output an electric signal according to a quantity of the light thus received.

8. The detection system of claim 4, wherein
the acquirer is configured to acquire, based on an image captured by an infrared imager sensitive to light in an infrared region, the distribution information on at least one of the ceiling surface or the floor surface.

9. The detection system of claim 1, wherein
the energy emitting unit is capable of outputting visible light in the predetermined direction.

10. The detection system of claim 9, wherein
the acquirer is configured to acquire the distribution information on a basis of detection results by a plurality of visible-light sensors disposed on at least one of the ceiling surface or the floor surface, and
each of the plurality of visible-light sensors is configured to receive light in a visible light region and output an electric signal according to a quantity of the light thus received.

11. The detection system of claim 9, wherein
the acquirer is configured to acquire the distribution information on a basis of an image captured by a visible imager sensitive to light in a visible light region on at least one of the ceiling surface or the floor surface.

12. The detection system of claim 1, wherein
the environment control device is a first environment control device,
the detection system further includes a second environment control device configured to control an environment in the interior space of the room, and
the acquirer is configured to acquire the distribution information in a state where the second environment control device performs control such that the interior space of the room is in a predetermined state.

13. A detection method comprising:
an energy emitting process of causing an energy emitting unit to output electromagnetic wave energy including at least one of light or heat from an attachment position of an environment control device in a predetermined direction, the environment control device being configured to be installed on a ceiling surface of a room to control an environment in an interior space of the room;
an acquisition process of acquiring distribution information including at least one of first distribution information relating to an electromagnetic field intensity distribution on the ceiling surface of the room or second distribution information relating to an electromagnetic field intensity distribution on a floor surface of the room; and
a detection process of detecting, based on the distribution information acquired in the acquisition process, attachment position information relating to the attachment position of the environment control device on the ceiling surface.

14. The detection system of claim 5, wherein
the acquirer is configured to acquire the distribution information on a basis of sensing results by a plurality of temperature sensors disposed on at least one of the ceiling surface or the floor surface, and
each of the plurality of temperature sensors is configured to detect an ambient temperature.

15. The detection system of claim 5, wherein
the acquirer is configured to acquire the distribution information on a basis of sensing results by a plurality of infrared detection sensors disposed on at least one of the ceiling surface or the floor surface,
each of the plurality of infrared detection sensors is configured to receive light in an infrared region and output an electric signal according to a quantity of the light thus received.

16. The detection system of claim 5, wherein
the acquirer is configured to acquire, based on an image captured by an infrared imager sensitive to light in an infrared region, the distribution information on at least one of the ceiling surface or the floor surface.

17. The detection system of claim 2, wherein
the environment control device is a first environment control device,
the detection system further includes a second environment control device configured to control an environment in the interior space of the room, and
the acquirer is configured to acquire the distribution information in a state where the second environment control device performs control such that the interior space of the room is in a predetermined state.

18. The detection system of claim 3, wherein
the environment control device is a first environment control device,
the detection system further includes a second environment control device configured to control an environment in the interior space of the room, and
the acquirer is configured to acquire the distribution information in a state where the second environment control device performs control such that the interior space of the room is in a predetermined state.

19. The detection system of claim 4, wherein
the environment control device is a first environment control device,
the detection system further includes a second environment control device configured to control an environment in the interior space of the room, and
the acquirer is configured to acquire the distribution information in a state where the second environment control device performs control such that the interior space of the room is in a predetermined state.

20. The detection system of claim 5, wherein
the environment control device is a first environment control device,
the detection system further includes a second environment control device configured to control an environment in the interior space of the room, and
the acquirer is configured to acquire the distribution information in a state where the second environment control device performs control such that the interior space of the room is in a predetermined state.
